(19) United States
(12) Patent Application Publication
(10) Pub. No.: US 2008/0239933 A1
(43) Pub. Date: Oct. 2, 2008

(54) WRITABLE OPTICAL INFORMATION RECORDING MEDIUM, APPARATUS FOR REPRODUCING THE SAME, AND METHOD OF DETERMINING THE SAME

(75) Inventors: Young-min CHEONG, Seoul (KR); Hong Tao, Suwong-si (KR); Byoung-ho Choi, Hwaseong-si (KR); In-ho Hwang, Seongnam-si (KR); Shuichi Tasaka, Seongnam-si (KR); Kyung-geun Lee, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/970,025

(22) Filed: Jan. 7, 2008

(30) Foreign Application Priority Data
Mar. 30, 2007 (KR) 2007-31950

(51) Int. Cl. G11B 7/24

(52) U.S. Cl. 369/275.1

(57) ABSTRACT

A writable optical information recording medium, an apparatus for reproducing the same, and a method of determining the same are provided. The amplitude of a push-pull signal (PPS) of the writable optical information recording medium is determined to be within an amplitude range of a PPS of a reproduction-only optical information recording medium. Accordingly, it is possible to stably reproduce copy protected content by recognizing a loaded writable optical information recording medium as a medium of a reproduction-only type.

### CROSS-REFERENCE TO RELATED PATENT APPLICATION

This application claims the benefit of Korean Patent Application No. 2007-31950, filed Mar. 30, 2007, in the Korean Intellectual Property Office, the disclosure of which is incorporated herein in its entirety by reference.

### BACKGROUND OF THE INVENTION

1. Field of the Invention

Aspects of the present invention relate to a writable optical information recording medium, an apparatus for reproducing the same, and a method of determining the same, and more particularly, to a writable optical information recording medium which intentionally changes an amplitude of a push-pull signal (PPS), an apparatus for reproducing the same, and a method of determining the same.

2. Description of the Related Art

Presently, consumers generally watch high-definition movies at home and can reproduce a video tape or digital versatile disk (DVD) through a video tape reproduction apparatus or DVD reproduction apparatus by first purchasing the video tape or DVD video disk from a video store or borrowing a video tape or DVD from a video rental store. A latest title may not be in the video store or video rental store. Alternatively, when a title that is desired by a user has been lent to another user, the user has to wait until the title is returned. In order to concurrently include various titles that are desired by consumers, a space to hold and display the titles is required. Alternatively, it has been suggested that moving pictures be sold through the Internet by using a network infrastructure, which has recently rapidly developed. Thus, some companies are expected to begin a service for enabling a consumer or a rental store to directly produce a video disk by downloading video content through the Internet.

In order to provide such service, the video content has to be first recorded in a writable optical information recording medium, such as a DVD-R/RW/RAM. To commercialize the service, illegal copying has to be prevented, and in order to prevent illegal copying, in DVD-ROMs, a copy protection scheme has been used for a content scramble system (CSS). On the other hand, recently, the DVD copy control association (CCA) plans to provide CSS-encrypted content for a downloading service of digital movies. A writable DVD compatible with the CSS encrypted content is expected to be applied with the CSS.

However, although the CSS encrypted content is recorded in the writable DVD, a conventional DVD player, which is already on the market, cannot reproduce the writable DVD in which the CSS encrypted content is recorded because, in the conventional DVD player, firmware is designed to only allow DVD-ROMs, in which the CSS encrypted content is recorded, to be reproduced and to not allow the reproduction of the writable DVD in which the CSS encrypted content is recorded.

### SUMMARY OF THE INVENTION

Aspects of the present invention provide a writable optical information recording medium capable of stably reproducing copy protected content even in a conventional reproduction apparatus with a process of recognizing an optical information recording medium by using physical or optical variables of the optical information recording medium, an apparatus for reproducing the same, and a method of determining the same, so that a reproduction apparatus can correctly reproduce the writable optical information recording medium in which reproduction-only content is recorded, such as a writable DVD in which CSS encrypted content is recorded.

According to an aspect of the present invention, there is provided a writable optical information recording medium with grooves which produce a normalized PPS amplitude is within normalized PPS amplitude of a reproduction-only optical information recording medium.

According to another aspect of the present invention, there is provided an apparatus for reproducing a writable optical information recording medium of which the amplitude of a push pull signal (PPS) is within an amplitude range of a PPS of a reproduction-only optical information recording medium, the apparatus including: a pickup unit to receive reflected light obtained by irradiating the writable optical information recording medium with a beam; a signal processing unit to generate the PPS based on the amount of light that is detected in the pickup unit; and a control unit to determine the writable optical information recording medium as a type of a reproduction-only optical information recording medium, when the PPS generated by the signal processing unit is within the amplitude range of the PPS of the reproduction-only optical information recording medium.

According to another aspect of the present invention, there is provided a method of determining a recording medium in an apparatus for reproducing an optical information recording medium, including determining a medium type of a writable optical information recording medium of which the amplitude of a detected PPS (push pull signal) is within an amplitude range of a PPS of a reproduction-only optical information recording medium as a type of reproduction-only optical information medium.

According to another aspect of the present invention, there is provided a writable optical information recording medium, including a reflective layer to reflect an incident laser beam thereon; a recording layer to change an amount of reflected light of a laser beam and formed to have grooves which guide the laser beam so as to record or reproduce data; and a transparent substrate to transmit the laser beam therethrough, wherein the writable optical information recording medium is recognizable as a reproduction-only optical information recording medium.

According to another aspect of the present invention, there is provided a writable optical information recording medium, including a reflective layer to reflect an incident laser beam thereon; a recording layer to change an amount of reflected light of a laser beam and formed to have grooves which guide the laser beam so as to record or reproduce data; and a transparent substrate to transmit the laser beam therethrough, wherein the grooves have a depth that results in the writable optical information recording medium being recognized as a reproduction-only optical information recording medium so as to be playable in a reproducing apparatus unable to reproduce writable optical information recording media.

According to another aspect of the present invention, there is provided a method of reproducing a recording medium in an apparatus for reproducing an optical information recording medium, including generating and detecting a push pull signal (PPS) of the recording medium, wherein the recording medium is a writable optical information recording medium, and the writable optical information recording medium produces a push pull signal in a range of push pull signals identifiable as a reproduction-only optical information recording medium.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a flowchart illustrating a process of recognizing a writable optical information recording medium by using a push-pull signal (PPS);

FIG. 2 is a schematic cross-sectional view illustrating a writable optical information recording medium according to aspects of the present invention;

FIGS. 3 and 4 are graphs illustrating relations between a groove depth of the writable optical information recording medium of FIG. 2 and a PPS;

FIGS. 5 and 6 are graphs respectively illustrating a relation between a groove depth of the writable optical information recording medium of FIG. 2 and jitter, and a relation between the groove depth and a radio frequency (RF) signal, according to aspects of the present invention;

FIG. 7 is a graph illustrating a relation between the height of bubbles formed on a mark and jitter, when recording data in the writable optical information recording medium of FIG. 2;

FIG. 8 is a graph illustrating a relation between a groove depth and jitter, when bubbles with the height of 20 nm are formed on the writable optical information recording medium of FIG. 2;

FIG. 9 is a graph illustrating characteristics of an RF signal and a DPD signal of a conventional DVD-R;

FIGS. 10A to 10I are graphs illustrating characteristics of an RF signal and a DPD signal, when the amplitude of a PPS of the writable optical information recording medium of FIG. 2 ranges from 0.22 to 0.06;

FIG. 11 is a block diagram illustrating an apparatus for reproducing a writable optical information recording medium, according to aspects of the present invention; and

FIG. 12 is a flowchart illustrating a method of determining a writable optical information recording medium by using a PPS according to aspects of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

Hereinafter, a writable optical information recording medium according to aspects of the present invention will be described in detail with reference to the attached drawings.

First, problems which may occur when content recorded in a reproduction-only medium, such as content scramble system (CSS)-encrypted content, is stored in a conventional writable optical information recording medium will be described.

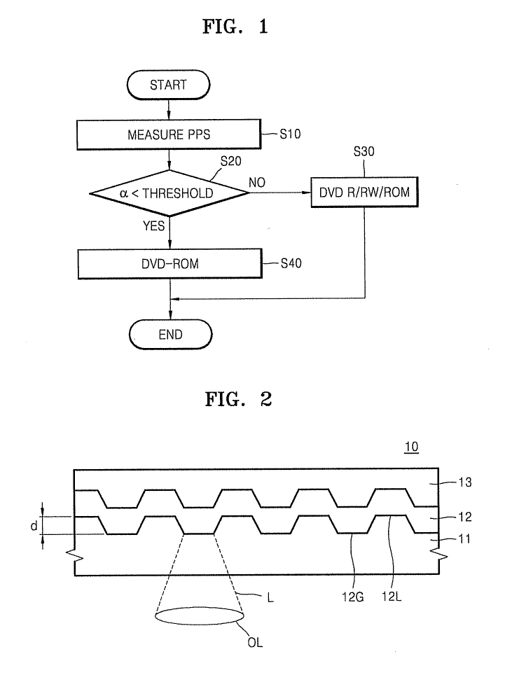

FIG. 1 illustrates a process of recognizing a type of a digital versatile disk (DVD) by using a push-pull signal (PPS). Referring to FIG. 1, when a DVD is loaded in a DVD player, the PPS is firstly measured (operation S10), and a value a that is determined by using the PPS is compared with a predetermined threshold value (operation S20). For example, the value a may be a normalized value of the PPS. Thus, when the value a is greater than the threshold value, the DVD is determined to be a writable DVD such as a digital versatile disk-writable (DVD-R), digital versatile disk-rewritable (DVD-RW), or digital versatile disk-read only memory (DVD-ROM) (operation S30). When the value a is less than the threshold value, the DVD is determined to be a DVD-ROM (operation S40). When a writable DVD, in which the CSS-encrypted content is recorded, is loaded in the DVD player with a process of recognizing the optical information recording medium, the DVD player recognizes the loaded DVD as the writable DVD from the PPS signal of the loaded writable DVD.

However, the DVD player having the aforementioned process of recognizing the medium cannot correctly reproduce a writable optical information recording medium when content for recording in the reproduction-only recording medium, such as CSS-encrypted content recorded in the DVD-ROM, is provided online and stored as a format of the reproduction-only recording medium in the writable optical information recording medium.

For example, firmware is previously installed in a conventional DVD player that enables the content to be reproduced only when the CSS-encrypted content is recorded in a reproduction-only medium such as a DVD-ROM. Thus, content cannot be reproduced by the DVD player in which the firmware is previously installed when the CSS-encrypted content is recorded in the writable DVD. In addition, the conventional DVD player may stop operating or malfunction because the conventional DVD player determines that a medium type, as determined from physical properties of the loaded DVD, and a format of the recorded content do not match even when the conventional DVD player lacks the firmware that prevents the reproduction of a writable DVD in which the CSS encrypted content is recorded.

Accordingly, is possible to normally reproduce the content having a reproduction-only format from a writable medium, such as CSS encrypted content in a writable optical information recording medium, by using a writable optical information recording medium of which the PPS is within an amplitude range of the reproduction-only optical information recording medium.

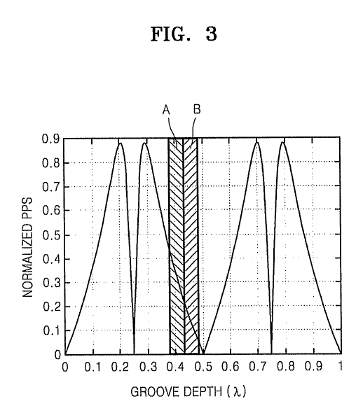

FIG. 2 is a schematic cross-sectional view illustrating a writable optical information recording medium 10 according to aspects of the present invention. The writable optical information recording medium 10 according to aspects of the present invention will be described by exemplifying a write-once DVD-R type which uses a laser beam L with a wavelength of 650 nm. That is, layers of the writable optical information recording medium 10 substantially have the same structures as those of the conventional DVD-R except for a depth d of a plurality of grooves 12G.

Referring to FIG. 2, the writable optical information recording medium 10 has a structure including a transparent substrate 11, a recording layer 12 formed on the transparent substrate 11, and a reflective layer 13. Although not shown, a protective layer and a substrate are further formed on the reflective layer 13. The transparent substrate 11 may be formed of polycarbonate. The reflective layer 13 reflects an incident laser beam and may be formed of aluminum, copper, or gold. The recording layer 12 may be formed of a photochromic material that causes a change in the amount of reflected light of a laser beam L with a predetermined power focused by an objective lens OL on the recording layer 12 of the writable optical information recording medium 10.

The recording layer 12 also has a structure in which the grooves 12G, which guide the laser beam L to record or reproduce data, may be formed by forming the recording layer 12 on the transparent substrate 11 in which the grooves 12G are previously formed.

As the grooves 12G may be previously formed before recording data, it is possible to track an optical pickup by using the grooves 1 2G when initially recording data. A method using the PPS is widely used as a method of tracking. As described in the following, the PPS can be obtained by using a signal difference by receiving light diffracted in an edge between the grooves 12G and lands 12L through a two-split photodiode.

In a writable optical information recording medium, a recording method or a recording location is slightly different depending on whether the writable optical information recording medium is writable or depending on the possible number of writing operations. For example, information is recorded onto pits without grooves in a DVD-ROM. In a DVD-R of a write-once type, information is recorded onto grooves. In a DVD-RW of a rewritable type, information is recorded on lands and grooves. As described above, since the presence of grooves and the shape of the grooves change depending upon the type of the writable optical information recording medium, the amplitude of the PPS is changed based on the type of the writable optical information recording medium. For example, since there are not any grooves in the reproduction-only DVD-ROM and since information is recorded onto pits, the PPS of the DVD-ROM is different from those of the DVD-R, the DVD-RW, and the DVD-ROM. The writable optical information recording medium 10 according to aspects of the present invention is designed such that the normalized PPS is within a range of the normalized PPS amplitude of the DVD-ROM. Accordingly, as described in the following, in a reproducing apparatus that employs an algorithm for determining a type of a recording medium by using the PPS amplitude, the writable optical information recording medium 10 is determined to be the DVD-ROM type.

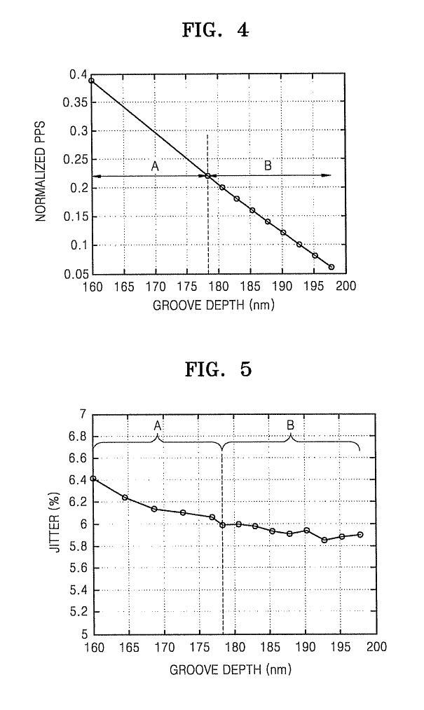

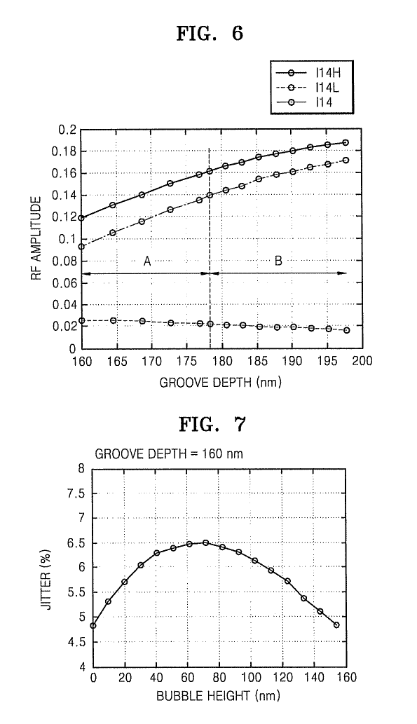

As described in FIGS. 3 and 4, as the depth d of the grooves 12G has a correlation with the amplitude of the PPS, the writable optical information recording medium 10 according to aspects of the present invention adjusts a normalized amplitude of the PPS by changing in terms of the depth d of the grooves 12G. Accordingly, the depth d of the grooves 12G is different from that of a conventional writable optical information recording medium. A physical structure of the writable optical information recording medium 10 according to aspects of the present invention is the same as that of the convention writable optical information recording medium except for the aforementioned groove depth d.

On the other hand, when it is assumed that a wavelength of a reproduction beam is λ, since a pit depth of the DVD-ROM is generally λ/4, the amplitude of the PPS of the DVD-ROM is theoretically zero. However, the PPS of the DVD-ROM is present due to an error in manufacturing of a disk. The following Table 1 is data obtained by measuring the PPS of the DVD-ROM.

TABLE 1

| DVD-Video | PPS (mV) | DV level (mV) | normalized PPS |
|---|---|---|---|
| Single layer #1 | 143.1 | 1044 | 0.137 |
| Single layer #2 | 128.8 | 948 | 0.137 |
| Dual layer #1 (L0) | 39.4 | 346 | 0.114 |
| Dual layer #1 (L1) | 42.6 | 334 | 0.128 |

Referring to Table 1, although the PPS amplitude in a case where the DVD-ROM has a single layer structure is different from the PPS amplitude in a case where the DVD-ROM has a double layer structure, the normalized PPS amplitudes of the DVD-ROMs are about 0.1. Accordingly, the normalized PPS amplitude may be about 0.1 in the writable optical information recording medium 10 according to aspects of the present invention. On the other hand, the normalized PPS of a conventional DVD-R is 0.38 and at least required to range from 0.22 to 0.44, due to the size of the conventional DVD-R. Accordingly, it is preferable to determine the depth d of the grooves 12G of the writable optical information recording medium 10 according to aspects of the present invention so that the amplitude of the normalized PPS ranges from 0.06 to 0.22. The amplitude of the PPS normalized within the range from 0.06 to 0.22 is outside of the amplitude of the normalized PPS of the conventional PPS and within the amplitude range of the PPS of the DVD-ROM.

FIGS. 3 and 4 are graphs illustrating normalized PPS amplitude according to a depth of grooves in a DVD-R disk. In FIGS. 3 and 4, a region A corresponds to a depth of grooves of a conventional DVD-R disk. A region B corresponds to the depth d of the grooves 12G according to aspects of the present invention. Referring to FIG. 3, when the wavelength of the reproduction beam is assumed to be λ, the depth of the grooves of the conventional DVD-R ranges from 0.38 λ to 0.43 λ. However, the depth d of the grooves 12G according to aspects of the present invention ranges from 0.43 λ to 0.48 λ. Referring to FIG. 4, as the wavelength of the reproduction beam of the DVD is specifically 650 nm, the depth of grooves of the conventional DVD-R ranges from 156 nm to 178 nm. However, the depth of the grooves 12G according to aspects of the present invention is from 178 nm to 198 nm.

As described above, although the writable optical information recording medium 10 according to aspects of the present invention has the DVD-R type having the recording layer 12 which is changed by irradiation of the laser beam, the amplitude of the normalized PPS is the same as that of the DVD-ROM.

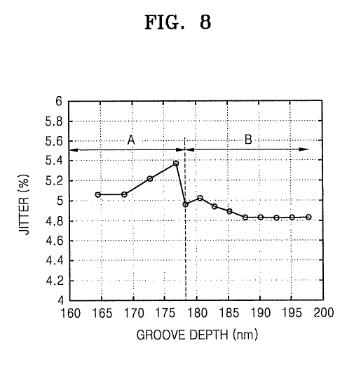

A signal characteristic in addition to the PPS characteristic of the writable optical information recording medium 10 according to aspects of the present invention will be described with reference to FIGS. 5 to 10I.

Grooves 12G of FIG. 2 serve to guide a laser beam for recording data. The grooves 12G are designed to optimize signal quality in consideration of reproduction properties of recorded data and/or servo signal characteristics. The writable optical information recording medium 10 according to aspects of the present invention has signal characteristics substantially the same as those of the conventional DVD-R except for the PPS amplitude.

FIG. 5 is a graph illustrating a relation between a jitter value and the PPS, according to aspects of the present invention. Referring to FIG. 5, when the depth of the grooves of the conventional DVD-R is 0.389 λ, the jitter value is 6.49%. As the depth of the grooves of the conventional DVD-R increases, the jitter value decreases. That is, a jitter characteristic is improved in the region B having the grooves 1 2G according to aspects of the present invention rather than in the region A with the grooves of the conventional DVD-R.

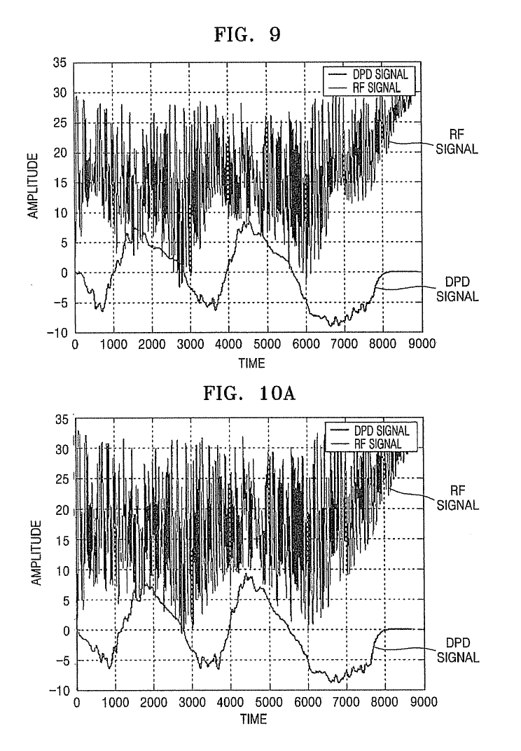

FIG. 6 is a graph illustrating a relation between a depth d of grooves 12G and an RF signal, according to aspects of the present invention. In the RF signal, which reproduces a mark with a maximum length of 14 T, the maximum value is represented by I14H, the minimum value is represented by I14L, and the width variation is represented by I14. Referring to FIG. 6, the maximum and minimum values I14H and I14L from among the RF signals increase, as the depth of the grooves 12G increases, and the width variation I14 decreases. Accordingly, the maximum and minimum values I14H and I14L of the RF signal increase in the region B having the depth of the grooves 12G according to aspects of the present invention in comparison to the maximum and minimum values I14H and I14L in the region A having the depth of the grooves of the conventional DVD-R.

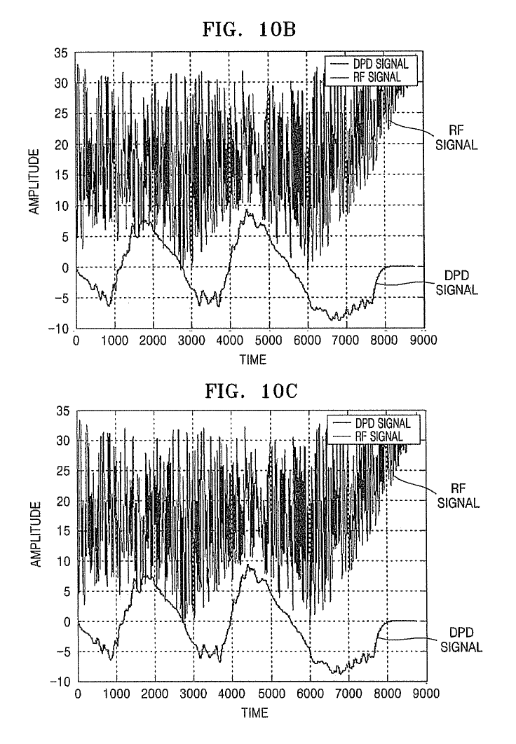

The writable optical information recording medium 10 according to aspects of the invention is described as a DVD-R type; however, aspects of the present invention are not limited thereto. When a laser beam with a predetermined recording power is incident onto the recording layer 12, the recording layer 12 is deformed so as to generate bubbles. FIG. 7 illustrates a change in jitter according to the height of the bubbles, when the depth d of the grooves 12G is 160 nm. Referring to FIG. 7, when the height of the bubbles is 70 nm, that is, about half of the depth d of the grooves 12G, jitter increases to its maximum because signals are attenuated due to the bubbles. However, when the height of the bubbles is 20 nm, the jitter value is decreased.

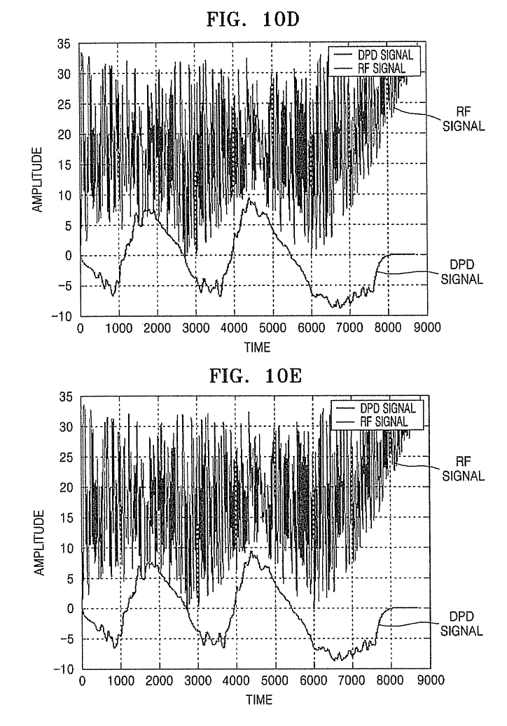

FIG. 8 illustrates a relation between the depth of grooves and the jitter of the writable optical information recording medium 10 with bubbles having a height of 20 nm, according to aspects of the present invention. Referring to FIG. 8, a jitter characteristic is improved in the region B having the grooves 12G according to aspects of the present invention rather than in the region A having the grooves of the conventional DVD-R. Referring to FIGS. 7 and 8, although the writable optical information recording medium 10 according to aspects of the present invention has the depth d of the grooves 12G that is greater than that of the grooves of the conventional DVD-R, when the bubble size is the same, the jitter characteristic is not deteriorated as compared to that of the conventional DVD-R. On the other hand, the size of the bubbles closely relates to the power of the incident laser beam. Although the power of the reproduction beam suitable for the conventional DVD-R is used, the reproduction signal of the writable optical information recording medium 10 according to aspects of the present invention is of a high quality.

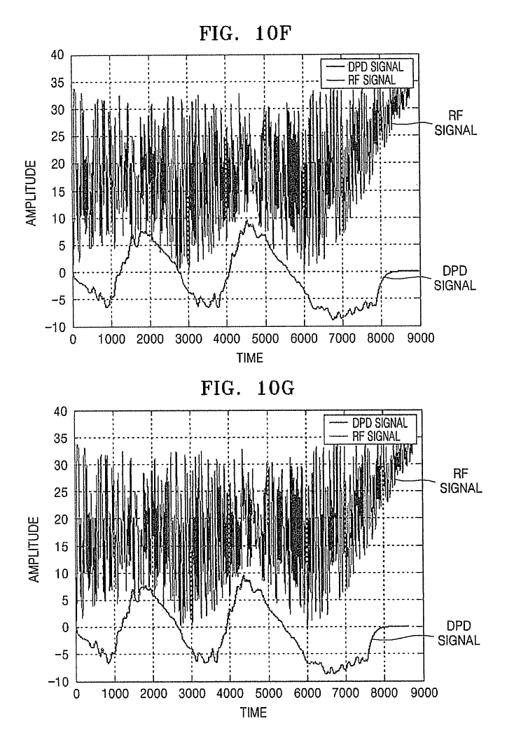

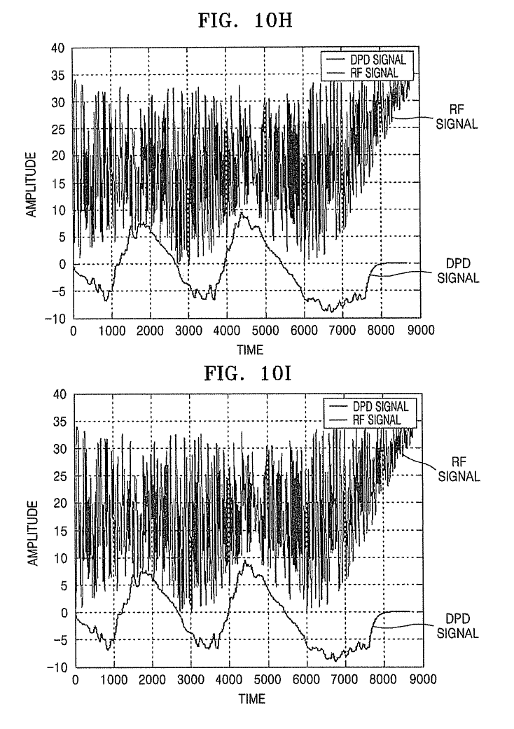

A tracking servo characteristic according to the present embodiment will be described. FIG. 9 illustrates a RF signal characteristic and a differential phase detection (DPD) signal characteristic of a DVD-R with the conventional normalized PPS amplitude, according to aspects of the present invention. On the other hand, FIGS. 10A to 10I respectively illustrate characteristics of an RF signal and a DPD signal, when the normalized PPS amplitude is 0.22, 0.20, 0.18, 0.16, 0.14, 0.12, 0.10, 0.08, and 0.06, according to aspects of the present invention. By comparing FIG. 9 with FIGS. 10A to 10I, the characteristics of the RF signal and the DPD signal shown in FIGS. 10A to 10I are substantially similar to those shown in FIG. 9. That is, although the depth d of the grooves 12G in the writable optical information recording medium 10 according to aspects of the present invention is greater than the depth of the grooves of the conventional DVD-R, the tracking servo is sufficiently performed by applying a DPD method, and thus, the RF characteristic is good.

Then, an apparatus for reproducing the writable optical information recording medium 10 according to aspects of the present invention and a method of determining the writable optical information recording medium 10 will be described.

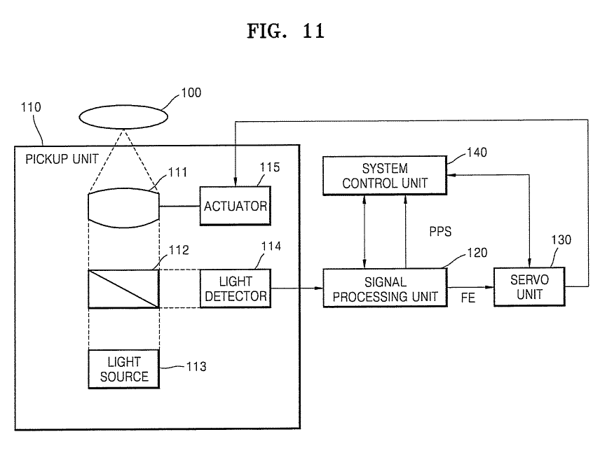

FIG. 11 is a block diagram illustrating the apparatus for reproducing a writable optical information recording medium according to aspects of the present invention. Referring to FIG. 11, the reproducing apparatus comprises a pickup unit 110, a signal processing unit 120, a servo unit 130, and a system control unit 140. The pickup unit 110 comprises an objective lens 111, a beam splitter 112, a light source 113, a light detector 114, and an actuator 115. The light detector 114 may comprise light detecting elements, such as a multi-split photodiode so as to obtain an RF signal and a PPS, from light reflected from the writable optical information recording medium 100. However, the apparatus for reproducing a writable optical information recording medium according to aspects of the present invention is not limited to FIG. 11 and may include other features, such as additional light detectors, collimating lenses, actuators, light sources, etc.

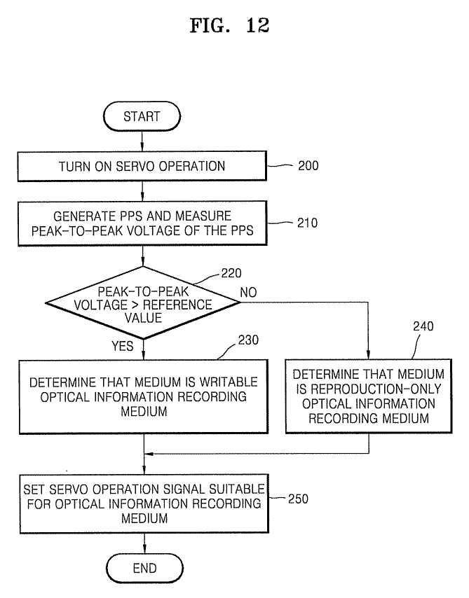

FIG. 12 is a flowchart illustrating a method of determining a writable optical information recording medium by using a PPS according to aspects of the present invention. The method of determining an optical information recording medium by using the PPS includes performing a servo operation (operation 200), generating a PPS and measuring a peak-to-peak voltage of the PPS (operation 210), determining whether the peak-to-peak voltage is within a range of a reference value (operation 220), determining that the optical information recording medium is a writable optical information recording medium, if the peak-to-peak voltage is higher than a reference voltage (operation 230), determining that the optical information recording medium is a reproduction-only optical information recording medium, if the peak-to-peak voltage is lower than the reference voltage (operation 240), and setting a servo operation signal suitable for the corresponding optical information recording medium (operation 250).

Referring to FIGS. 11 and 12, when an optical information recording medium 100 is loaded, the system control unit 140 performs the servo operation so as to determine a medium type (operation 200). The system control unit 140 requests the servo unit 130 to perform in a focus servo operation to determine the medium type, while providing a command to the signal processing unit 120 to request the laser diode 113 to be powered on. Accordingly, the signal processing unit 120 provides power to drive the laser diode 113 through an auto laser power control (ALPC) signal (not shown) which automatically controls the power of the laser diode 113. In order to allow the pickup unit 110 to perform a focusing operation on the optical information recording medium 100, the servo unit 130 moves the objective lens 111 up or down (i.e., closer to or farther from the optical information recording medium 100) according to an upward or downward movement of the focusing actuator 115 to focus the objective lens 111 on a signal surface of the optical information recording medium 100. Then, the optical detector 114 detects a beam reflected through the beam splitter 112 and transmits the detected beam to the signal processing unit 120. The signal processing unit 120 generates a PPS based on an amount of light detected by the light detector 114 and measures a peak-to-peak voltage of the PPS (operation 210). The signal processing unit 120 generates an RF SUM signal and generates a PPS. When the light detector 114 is a quadrant light detector, the RF SUM signal is generated by adding up signals that are detected by light receiving elements A to D of a quadrant light detector 114 and the PPS is generated by subtracting a sum signal V1 obtained by adding up signals detected by light receiving elements B and C, a radial pair of light receiving elements, from a sum signal V2 obtained by adding up signals detected by light receiving elements A and D, the other radial pair of light receiving elements of the quadrant light detector. Furthermore, the signal processing unit 120 enables the servo unit 130 to perform a servo operation by generating a servo signal such as a focus error signal FE based on the amount of light detected by the light detector 114.

The system control unit 140 determines whether the peak-to-peak voltage of the PPS is higher than the range about a reference value (operation 220). When the optical information recording medium 100 is a reproduction-only recording medium such as a DVD-ROM, as the depth of pits in the reproduction-only recording medium is less than that in the writable recording medium, the peak-to-peak voltage of the PPS is lower than the reference value. When the optical information recording medium 100 is a writable recording medium such as a DVD-R, as the depth of pits in the writable recording medium is greater than that in the reproduction-only recording medium, the peak-to-peak voltage of the PPS is higher than the reference value.

Accordingly, when the peak-to-peak voltage of the PPS is higher than the reference value, the optical information recording medium 100 is determined to be a writable optical information recording medium (operation 230). Similarly, when the peak-to-peak voltage of the PPS is less than the reference value, the optical information recording medium 100 is determined to be a reproduction-only optical information recording medium (operation 240).

When the optical information recording medium 100 is determined to be a writable or reproduction-only recording medium, the system control unit 140 sets a servo control signal for a servo operation suitable for the corresponding optical information recording medium 100 and outputs the servo control signal to the servo unit 130 (operation 250).

As described above, as the medium type is determined by using the PPS amplitude of the loaded optical information recording medium 100, a writable optical information recording medium of which the PPS amplitude is within a range of the PPS amplitude of the reproduction-only optical information recording medium is determined to be a reproduction-only recording medium. Accordingly, when a user or a transferor directly records content that is formatted appropriately for a reproduction-only optical information recording medium in the writable optical information recording medium according to aspects of the present invention, a reproduction apparatus which reproduces the content can correctly reproduce the recorded content as the optical information recording medium is determined to be a reproduction-only recording medium. For example, when firmware is installed in the reproduction apparatus so that the CSS encrypted content can be reproduced only when the CSS encrypted content is recorded in the DVD-ROM and a loaded DVD-R type optical disk in which the CSS encrypted content is recorded is a writable optical information recording medium according to aspects of the present invention, the reproduction apparatus recognizes the loaded optical disk as an optical disk of the DVD-ROM type and reproduces the CSS encrypted content without limitations.

In the above description, the DVD-R type is described as an example of the writable optical information recording medium. However, as aspects of the present invention use a difference between a PPS characteristic according to the groove structure necessary for the writable optical information recording medium and a PPS characteristic according to a reproduction-only optical information recording medium with the pit structure, aspects of the present invention are not limited to the DVD-R and can be applied to a DVD+R, a DVD±RW, and a DVD-RAM, in addition to the DVD-R. Furthermore, according to aspects of the present invention can be applied to a Blu-ray Disc (BD) or a high definition (HD) DVD.

As described above, as the writable optical information recording medium according to aspects of the present invention has a PPS of which the amplitude is less than that of the conventional PPS, the writable optical information recording medium according to the embodiment is recognized as a medium with a reproduction-only optical information recording medium type by a reproduction apparatus which recognizes a disk type by using the PPS. Accordingly, the user can record copy-protected content in the writable optical information recording medium according to aspects of the present invention. The writable optical information recording medium, in which the copy-protected content is recorded, can be reproduced even by a reproduction apparatus in which firmware is installed so as to prevent the writable optical information recording medium containing the copy-protected content from being reproduced. Furthermore, in the apparatus for reproducing the writable optical information recording medium according to aspects of the present invention and the method of determining a medium thereof, although content recorded in the writable optical information recording medium has a reproduction-only format, it is possible to normally reproduce the content.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A writable optical information recording medium,
wherein an amplitude of a push pull signal (PPS) is within an amplitude range of a PPS of a reproduction-only optical information recording medium.

2. The writable optical information recording medium of claim 1,
wherein the PPS of the writable optical information recording medium and the PPS of the reproduction-only optical information recording medium are normalized values.

3. The writable optical information recording medium of claim 2,
wherein the writable optical information recording medium is a DVD-R, and the normalized value of the PPS of the writable optical information recording medium ranges from 0.06 to 0.22.

4. The writable optical information recording medium of claim 1,
wherein the writable optical information recording medium includes grooves.

5. The writable optical information recording medium of claim 4,
wherein the amplitude of the PPS of the writable optical information recording medium is adjusted by changing a depth of the grooves.

6. The writable optical information recording medium of claim 5,
wherein the writable optical information recording medium is a DVD-R, a wavelength of a reproduction laser beam is λ, and the depth of the grooves is greater than 0.43 λ and less than or equal to 0.48 λ.

7. The writable optical information recording medium of claim 6,
wherein the depth of the grooves is greater than 178 nm and less than or equal to 198 nm.

8. The writable optical information recording medium of claim 1,
wherein the writable optical information recording medium is of a write-once type or a rewritable type.

9. The writable optical information recording medium of claim 1,
wherein the writable optical information recording medium is one of a DVD-R, a DVD+R, a DVD-RW, a DVD+RW, and a DVD-RAM.

10. An apparatus for reproducing a writable optical information recording medium of which an amplitude of a push pull signal (PPS) is within an amplitude range of a PPS of a reproduction-only optical information recording medium, the apparatus comprising:
a pickup unit receiving reflected light obtained by irradiating the writable optical information recording medium with a beam;
a signal processing unit generating the PPS based on the amount of light that is detected in the pickup unit; and
a control unit to determine the writable optical information recording medium as a type of a reproduction-only optical information recording medium when the PPS generated by the signal processing unit is within the amplitude range of the PPS of the reproduction-only optical information recording medium.

11. The apparatus of claim 10, wherein the generated PPS and the PPS of the reproduction-only optical information recording medium are normalized values.

12. The apparatus of claim 11, wherein the writable optical information recording medium is a DVD-R, the normalized value of the PPS of the writable optical information recording medium ranges from 0.06 to 0.22, and the control unit determines the writable optical information recording medium to be a DVD-ROM type.

13. The apparatus of claim 10, wherein the writable optical information recording medium is of a write-once type or a rewritable type.

14. The apparatus of claim 10, wherein the writable optical information recording medium is one of a DVD-R, a DVD+R, a DVD-RW, a DVD+RW, and a DVD-RAM.

15. A method of determining a recording medium in an apparatus for reproducing an optical information recording medium, comprising:
determining a medium type of a writable optical information recording medium of which an amplitude of a detected push pull signal (PPS) is within an amplitude range of a PPS of a reproduction-only optical information recording medium as a type of reproduction-only optical information medium.

16. The method of claim 15, wherein the detected PPS and the PPS of the reproduction-only recording medium are normalized values.

17. The method of claim 16, wherein the writable optical information recording medium is a DVD-R, the normalized value of the PPS of the writable optical information recording medium ranges from 0.06 to 0.22, and the writable optical information recording medium is determined as a DVD-ROM type.

18. The method of claim 15, wherein the writable optical information recording medium is of a write-once type or a rewritable type.

19. The method of claim 15, wherein the writable optical information recording medium is one of a DVD-R, a DVD+R, a DVD-RW, a DVD+RW, and a DVD-RAM.

20. A writable optical information recording medium, comprising:
a reflective layer to reflect an incident laser beam thereon;
a recording layer to change an amount of reflected light of the laser beam and formed to have grooves which guide the laser beam so as to record or reproduce data; and
a transparent substrate to transmit the laser beam therethrough,
wherein the writable optical information recording medium is determined to be a reproduction-only optical information recording medium when read by an apparatus for reproducing an recording medium.

21. A method of reproducing a writable optical information recording medium in an apparatus for reproducing an optical information recording medium, comprising:
generating and detecting a push pull signal (PPS) of the writable optical information recording medium,
wherein the writable optical information recording medium produces a push pull signal in a range of push pull signals identifiable as a reproduction-only optical information recording medium.

22. The method of claim 21, wherein the generating and detecting the PPS comprises focusing a reproduction laser beam on grooves of the writable optical information recording medium,
wherein a depth of the grooves determines the push pull signal.

23. The method of claim 22, wherein a wavelength of the reproduction laser beam is λ, and the depth of the grooves is greater than 0.43 λ and less than or equal to 0.48 λ.

24. The method of claim 22, wherein the depth of the grooves is greater than 178 nm and less than or equal to 198 nm.
